(19) United States
(12) Patent Application Publication
(10) Pub. No.: US 2022/0267963 A1
(43) Pub. Date: Aug. 25, 2022

(54) TRACK ASSEMBLY TOOL

(71) Applicants: Mario HANSL, Los Angeles, CA (US); Grahme WILLIAMS, Los Angeles, CA (US); Jett FERM, Los Angeles, CA (US); HYPERLOOP TECHNOLOGIES, INC., Los Angeles, CA (US)

(72) Inventors: Mario HANSL, Los Angeles, CA (US); Grahme WILLIAMS, Los Angeles, CA (US); Jett FERM, Los Angeles, CA (US)

(73) Assignee: HYPERLOOP TECHNOLOGIES, INC., Los Angeles, CA (US)

(21) Appl. No.: 17/630,083

(22) PCT Filed: Jul. 27, 2020
(86) PCT No.: PCT/US2020/043721

§ 371 Date: Jan. 25, 2022

Related U.S. Application Data
(60) Provisional application No. 62/879,053, filed on Jul. 26, 2019.

(51) Int. Cl. E01B 37/00; E01B 25/30

(52) U.S. Cl. CPC E01B 37/00; E01B 25/305; B60L 13/04

(57) ABSTRACT

Method of forming track section includes coupling functional components to a framework. At least some of the functional components are arranged in a precise and accurate arrangement in a common plane. Building a rigid, removable, and reusable mold around the framework and functional components. Steel reinforcement (“rebar”), which is bent into a shape corresponding to a track section profile, is provided within the mold. Dispensing a binder material into the mold and curing the binder material; and removing the mold from the cured binder material to reveal a completed track section at required accuracy set by the framework. At least some other functional components are arranged parallel to each other in a first lateral plane normal to the common plane and at least still other functional components are arranged parallel to each other in a second lateral plane normal to the common plane and parallel to the first lateral plane.

### CROSS-REFERENCE TO RELATED APPLICATION

This International Application claims the benefit of U.S. Provisional Application No. 62/879,053 filed Jul. 26, 2019, the disclosure of which is expressly incorporated by reference in its entirety.

### BACKGROUND

### 1. Field of the Disclosure

Aspects and implementations of the present disclosure relate to a track assembly tool and, in particular, a track assembly tool used to fabricate tracks (“track”), e.g., stationary or fixed track, of a magnetic levitation (maglev) vehicle.

### 2. Background of the Disclosure

Maglev trains use electromagnetic control systems to provide lift to push the train up off of a track and an electromagnetic engines to propel the train along the track. Complex forms and precision placement of maglev track and maglev components are known problems in the fabrication of maglev train systems.

### SUMMARY

Aspects and embodiments of the disclosure are directed to a track assembly tool to fabricate sections of magnetic levitation (maglev) track. The track assembly tool is a high tolerance installation template for cross-sectional precision setting of multiple track functional surfaces, which can be used sequentially, as a standard part to build a guideway. Embodiments of the track assembly tool may be utilized to efficiently produce sections of maglev track assemblies within manufacturing tolerances to ensure the desired and proper orientation of a maglev vehicle to be guided over or along the maglev track with respect to lift/levitation and propulsion.

Embodiments of the track assembly tool allow for the proper and accurate positioning of functional elements prior to anchoring these elements in a binder material, such as concrete or other moldable material.

Embodiments are directed to a method of forming a track section that includes coupling functional components to a framework, in which at least some of the functional components are arranged in a precise and accurate arrangement in a common plane, and building a rigid, removable, and reusable mold around the framework and functional components. Steel reinforcement (“rebar”), which is bent into a shape corresponding to a track section profile, is provided within the mold. Dispensing a binder material into the mold and curing the binder material; and removing the mold from the cured binder material to reveal a completed track section at the required accuracy set by the framework. At at least some other functional components are arranged parallel to each other in a first lateral plane normal to the common plane and at least still other functional components are arranged parallel to each other in a second lateral plane normal to the common plane and parallel to the first lateral plane.

According to embodiments, the at least some functional components in the common plane can include levitation rails and braking rails.

In accordance with other embodiments, the at least some other functional components and the at least still other components can include guidance rails and propulsion rails.

In embodiments, the framework can include placeholders arranged to receive and position the functional elements coupled to the framework.

According to still other embodiments, the functional elements may include anchors arranged to extend within the shaped rebar.

In accordance with other embodiments, the method can also include supporting the framework on at least one base supported on a ground surface. The building of the mold can include installing upper inner forms over upwardly facing portions of the framework and adjacent the functional components; installing lower inner forms in a region between the framework and the ground surface, lower supports being located adjacent the lower inner forms, wherein the rebar is supported on the lower supports; and installing outer forms over lateral sides of the track section shape of the rebar. Further, after removing the mold, the completed track section may be supported on the framework and the lower supports, and the method can also include lifting the completed track section from the framework and the lower supports; sliding, in a longitudinal direction, the completed track section relative to the framework and the lower supports; and removing the upper inner forms from an interior of the completed track section.

In still other embodiments, the framework may include a first alignment fixture and a second alignment fixture, and the method may also include supporting the first alignment fixture on a bottom tool form. The bottom tool form can include a plurality of tool locating post holes and a plurality of pitch locating post holes, into which a plurality of tool locating posts and a plurality of pitch locating posts are inserted, the first alignment fixture can include holes to receive the plurality of tool locating posts and the plurality of pitch locating posts and component receivers for retaining the at least some of the functional components to be arranged parallel to each other in the common plane. The first alignment fixture may be supported above the rebar and the method can also include positioning and aligning the at least some of the functional components, whereby the at least some of the functional components are arranged parallel to each other in the common plane. The building of the mold can include installing lower forms over longitudinal ends of the bottom form tool. The dispensing of the binder material may include dispensing the binder material to a level covering anchors of the at least some functional components and below the at least some functional components; and wherein the at least some functional components may include a levitation rail and braking rails.

In further embodiments, after a first predetermined curing period, the method can include removing the first alignment fixture from the bottom tool form; supporting the second alignment fixture on the tool locating posts; and coupling the at least some other functional components to the second alignment fixture in the first lateral plane normal to the common plane. The building of the mold can further include installing a first intermediate form above a first lateral edge of the bottom tool form and above the lower form in a region of the first lateral edge of the bottom tool form, the dispensing of the binder material can include dispensing the binder material to cover anchors of intermediate ones of the at least some other functional components and to provide a lateral separation between the intermediate ones of the at least some other functional components and the dispensed binder material; and the intermediate ones of the at least some other functional components may include a propulsion rail.

In still other embodiments, after a second predetermined curing period, the building of the mold further includes installing an first upper form above the first intermediate form, the dispensing of the binder material can further include dispensing the binder material to cover anchors of upper ones of the at least some other functional components and to provide a lateral separation between from the upper ones of the at least some other functional components and the dispensed binder material; and the upper ones of the at least some other functional components may include a guidance rail.

According to other embodiments, after a third predetermined curing period, the method can include removing the second alignment fixture from the bottom tool form and from the at least some other functional components; rotating the second alignment fixture and supporting the second alignment fixture on the tool locating posts; and coupling the at least still other functional components to the second alignment fixture in the second lateral plane normal to the common plane and parallel to the first lateral plane. The building of the mold may further include installing a second intermediate form above a second lateral edge of the bottom tool form and above the lower form in a region of the second lateral edge of the bottom tool form, and the dispensing of the binder material can further include dispensing the binder material to cover anchors of intermediate ones of the at least still other functional components and to provide a lateral separation between the intermediate ones of the at least still other functional components and the dispensed binder material; and the intermediate ones of the at least still other functional components may include a propulsion rail.

In accordance with further embodiments, after a fourth predetermined curing period, the building of the mold can further include installing an second upper form above the second intermediate form, and the dispensing of the binder material may further include dispensing the binder material to cover anchors of upper ones of the at least still other functional components and to provide a lateral separation between from the upper ones of the at least still other functional components and the dispensed binder material; and the upper ones of the at least still other functional components may include a guidance rail.

In further embodiments, after a fifth predetermined curing period, the first and second upper forms, the first and second intermediate forms and the lateral forms can be removed to reveal a completed track section.

Embodiments are directed to a track section tool for fabricating a track section, which includes a framework; and a plurality of placeholders connected to the framework. The plurality of placeholders are arranged to retain functional components to the framework during fabrication and to orient at least some of the functional components in a precise and accurate arrangement in a common plane, to orient at least some other of the functional elements parallel to each other in a first lateral plane normal to the common plane, and to orient at least still other functional components parallel to each other in a second lateral plane normal to the common plane and parallel to the first lateral plane. The at least some functional components in the common plane include a levitation rail and a braking rail, the at least some other functional components and the at least still other components include a guidance rail and a propulsion rail.

In accordance with still yet other embodiments, the track section tool can also include a bottom tool form having a plurality of tool locating post holes and a plurality of pitch locating post holes, and a plurality of tool locating posts and a plurality of pitch locating posts being insertable into the plurality of tool locating post holes and the plurality of pitch locating post holes. The framework can include a first alignment fixture having holes to receive the plurality of tool locating posts and the plurality of pitch locating posts and component receivers for retaining the at least some of the functional components to be arranged parallel to each other in the common plane, and a second alignment fixture having holes to receive the plurality of tool locating posts and the plurality of pitch locating posts and component receivers for retaining one of the at least some other functional components in the first lateral plane or the at least still other functional components in the second lateral plane.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIGS. 1A and 1B illustrate respective exemplary profile and cross-sectional views of an installation of a track assembly tool in accordance with embodiments of the disclosure;

FIGS. 2A and 2B illustrate respective exemplary profile and cross-sectional views of adding components of a maglev track to the track assembly tool in accordance with embodiments of the disclosure;

FIGS. 3A and 3B illustrate respective exemplary profile and cross-sectional views of adding an upper inner form to the track assembly tool in accordance with embodiments of the disclosure;

FIGS. 4 and 4B illustrate respective exemplary profile and cross-sectional views of adding a lower inner form to the track assembly tool in accordance with embodiments of the disclosure;

FIGS. 5A and 5B illustrate respective exemplary profile and cross-sectional views of installing rebar in accordance with embodiments of the disclosure;

FIGS. 6A and 6B illustrate respective exemplary profile and cross-sectional views of adding an outer form to the track assembly tool in accordance with embodiments of the disclosure;

FIGS. 7A and 7B illustrate respective exemplary profile and cross-sectional views of dispensing concrete or other moldable material within the track assembly tool in accordance with embodiments of the disclosure;

FIGS. 8A and 8B illustrate respective exemplary profile and cross-sectional views of removing the outer form and lower inner form from the track assembly tool in accordance with embodiments of the disclosure;

FIGS. 9A and 9B illustrate respective exemplary profile and cross-sectional views of removing the precision alignment placeholders from the track assembly tool in accordance with embodiments of the disclosure;

FIGS. 10A and 10B illustrate respective exemplary profile and cross-sectional views of lifting the section of track off of the track assembly tool in accordance with embodiments of the disclosure;

FIGS. 11A and 11B illustrate respective exemplary profile and cross-sectional views of sliding the section of track off of the track assembly tool in accordance with embodiments of the disclosure;

FIGS. 12A and 12B illustrate respective exemplary profile and cross-sectional views of the section of track including the upper inner forms in accordance with embodiments of the disclosure;

FIGS. 13A and 13B illustrate respective exemplary profile and cross-sectional views of the section of track in accordance with embodiments of the disclosure;

FIG. 14 illustrates an arrangement of the functional components for a section of track;

FIG. 15 illustrates a bottom tool form in accordance with another embodiment;

FIG. 16 illustrates placement of rebar on the bottom tool form;

FIG. 17 illustrates a bottom view of a first alignment fixture;

FIG. 18 illustrates the first alignment fixture located over the rebar on the bottom tool form;

FIG. 19 illustrates installation of forms on longitudinal ends of bottom form tool;

FIG. 20 illustrates the positioned and aligned functional components in the cured layer of binder material;

FIG. 21 illustrates a bottom view of a second alignment fixture;

FIG. 22 illustrates the second alignment fixture arranged over the positioned and aligned functional components;

FIG. 23 illustrates installation of forms for a next functional component on a first side of the section of track;

FIG. 24 illustrates the cured next layer of binder material on the first side of the section of track;

FIG. 25 illustrates installation of forms for a next functional component;

FIG. 26 illustrates the cured final layer of the first side of the section of track;

FIG. 27 illustrates the second alignment fixture and installed forms for forming the second side of the section of track;

FIG. 28 illustrates removal of the forms to reveal the completed section of track;

FIG. 29 illustrates the removal of the lower interior section of the form;

FIG. 30 illustrates the removal of the center interior section of the form, allowing embedments to pass through the framework; and

FIG. 31 illustrates a method to seal the interior form around embedments that pass through the form.

### DETAILED DESCRIPTION

The following detailed description illustrates by way of example, not by way of limitation, the principles of the disclosure. This description will clearly enable one skilled in the art to make and use the disclosure, and describes several embodiments, adaptations, variations, alternatives and uses of the disclosure, including what is presently believed to be the best mode of carrying out the disclosure. It should be understood that the drawings are diagrammatic and schematic representations of exemplary embodiments of the disclosure, and are not limiting of the present disclosure nor are they necessarily drawn to scale.

Embodiments of the present disclosure may be used in a transportation system, for example, as described in commonly-assigned U.S. Pat. No. 9,718,630, titled “Transportation System,” the contents of which are hereby expressly incorporated by reference herein in their entireties.

In the following description, the various embodiments of the present disclosure will be described with respect to the enclosed drawings. As required, detailed embodiments of the present disclosure are discussed herein; however, it is to be understood that the disclosed embodiments are merely exemplary of the embodiments of the disclosure that may be embodied in various and alternative forms. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ the present disclosure.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, such that the description, taken with the drawings, making apparent to those skilled in the art how the forms of the present disclosure may be embodied in practice.

As used herein, the singular forms “a,” “an,” and “the” include the plural reference unless the context clearly dictates otherwise. For example, reference to “a magnetic material” would also mean that mixtures of one or more magnetic materials can be present unless specifically excluded. As used herein, the indefinite article “a” indicates one as well as more than one and does not necessarily limit its referent noun to the singular.

Except where otherwise indicated, all numbers expressing quantities used in the specification and claims are to be understood as being modified in all examples by the term “about.” Accordingly, unless indicated to the contrary, the numerical parameters set forth in the specification and claims are approximations that may vary depending upon the desired properties sought to be obtained by embodiments of the present disclosure. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range (unless otherwise explicitly indicated). For example, if a range is from about 1 to about 50, it is deemed to include, for example, 1, 7, 34, 46.1, 23.7, or any other value or range within the range.

As used herein, the terms “about” and “approximately” indicate that the amount or value in question may be the specific value designated or some other value in its neighborhood. Generally, the terms “about” and “approximately” denoting a certain value is intended to denote a range within ±5% of the value. As one example, the phrase “about 100” denotes a range of 100±5, i.e. the range from 95 to 105. Generally, when the terms “about” and “approximately” are used, it can be expected that similar results or effects according to the disclosure can be obtained within a range of ±5% of the indicated value.

As used herein, the term “and/or” indicates that either all or only one of the elements of said group may be present. For example, “A and/or B” shall mean “only A, or only B, or both A and B”. In the case of “only A”, the term also covers the possibility that B is absent, i.e. “only A, but not B”.

The term “substantially parallel” refers to deviating less than 20° from parallel alignment and the term “substantially perpendicular” refers to deviating less than 20° from perpendicular alignment. The term “parallel” refers to deviating less than 5° from mathematically exact parallel alignment. Similarly “perpendicular” refers to deviating less than 5° from mathematically exact perpendicular alignment.

The term “at least partially” is intended to denote that the following property is fulfilled to a certain extent or completely.

The terms “substantially” and “essentially” are used to denote that the following feature, property or parameter is either completely (entirely) realized or satisfied or to a major degree that does not adversely affect the intended result.

The term “comprising” as used herein is intended to be non-exclusive and open-ended. Thus, for example a composition comprising a compound A may include other compounds besides A. However, the term “comprising” also covers the more restrictive meanings of “consisting essentially of” and “consisting of”, so that for example “a composition comprising a compound A” may also (essentially) consist of the compound A.

The embodiments disclosed herein can be used separately and/or in combination with each other, unless specifically stated to the contrary.

Aspects and embodiments of the disclosure are directed to a track assembly tool to fabricate sections of magnetic levitation (maglev) track. The track assembly tool is a high tolerance installation template for cross-sectional precision of multiple track functional surfaces, which can be used sequentially, as a standard part to build a guideway. The sections of maglev track (also referred to as “track” hereafter) may be less than 100 meters (m) and, in embodiments, between 50 and 100 m in length, to produce hundreds of kilometers of completed guideway. Accuracy of the above-noted high tolerance can be on the order of, e.g., less than 25 millimeters (mm) per 3 m of length, preferably less than 25 mm per 6 m length, more preferably less than 25 mm per 10 m length, even more preferably less than 25 mm per 50 m of length and most preferably less than 25 mm per 100 mm of length. These sections can have a width or gauge between 3 and 8 m. In other embodiments, sections of maglev track may be between 2 and 10 m long, and preferably 6 m or less in length, and most preferable about 3 m long, and with a width or gauge of 4.5 m. Embodiments of the track assembly tool may be utilized to efficiently produce sections of maglev track within manufacturing tolerances to ensure the desired and proper orientation of a maglev vehicle to be guided over or along the maglev track with respect to lift/levitation and propulsion.

Embodiments of the track assembly tool allow for the proper and accurate positioning of functional elements prior to anchoring these elements in a binder material, such as concrete or other moldable material.

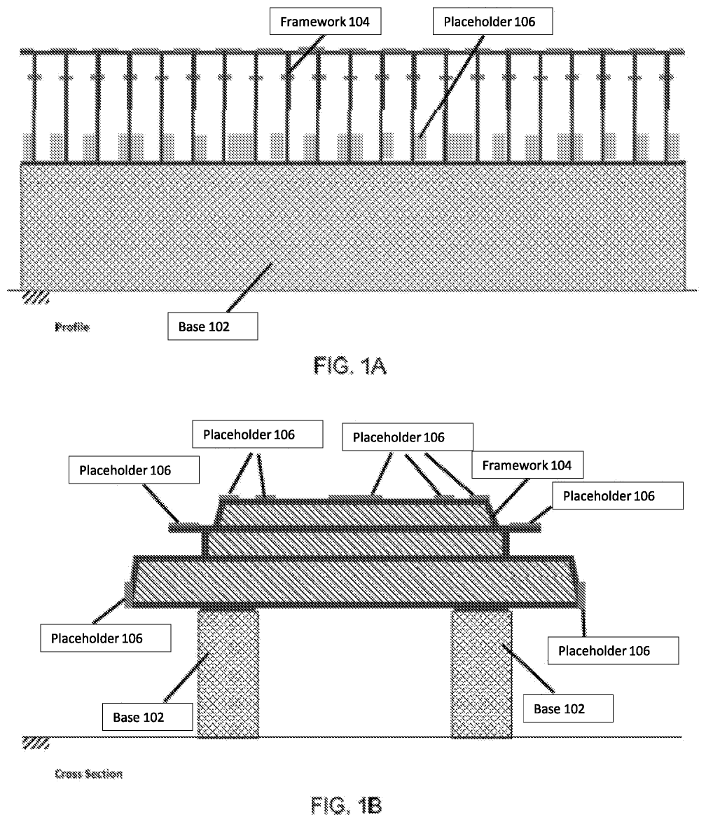

FIGS. 1A and 1B illustrate a profile view of an exemplary installation of a track assembly tool 1 in a length direction of the track and a cross-sectional view of the exemplary installation of track assembly tool 1, respectively, in accordance with embodiments of the disclosure. Track assembly tool 1 can include a framework 104, such as scaffolding, preferably steel, which can be supported on at least one base 102, e.g., a support pillar, such as a concrete base. Framework 104 can include horizontal or vertical support surfaces as well as support surfaces formed by extending flanges. Base 102 can extend along an entire length of framework 104 or multiple bases 102 can be used to support framework 104 in the length direction. Moreover, placeholders 106 may be provided on framework 104 to support functional components, e.g., track, wayside support systems, lighting, surveying monuments, emergency equipment, etc., for precise positioning and alignment of the components during the fabrication process. Placeholders 106 can be, e.g., raised surfaces or platforms, pins, flanges, guides, locating elements, fixture rests, clamping circuits, etc. and can be fixedly or removably coupled to framework 104 at predetermined locations corresponding to positions for supporting and positioning the functional components.

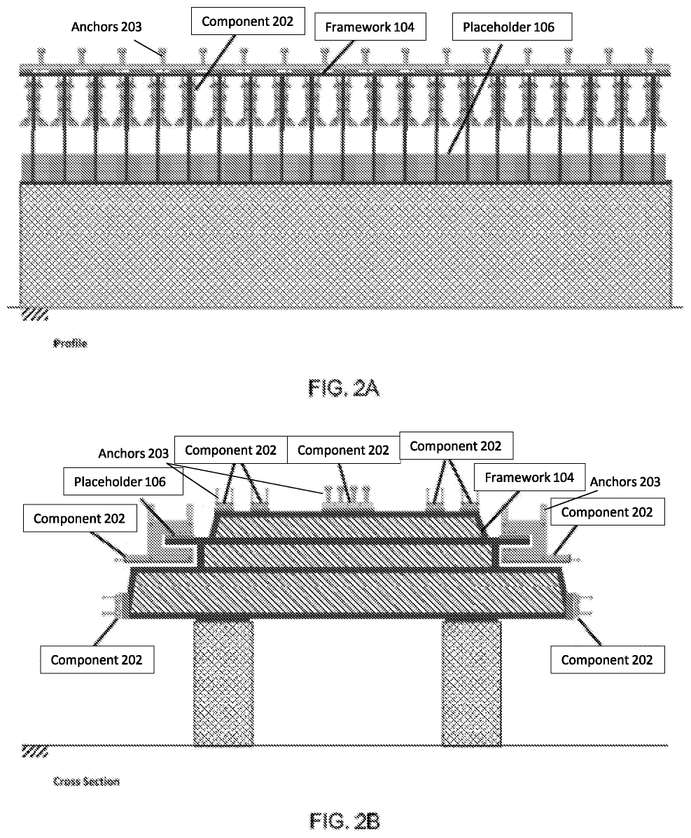

FIGS. 2A and 2B illustrate the exemplary profile view and cross-sectional view of FIGS. 1A and 1B, respectively, which additionally include the positioning and alignment of functional components 202 on or over framework 104 at or along placeholders 106 in accordance with this exemplary embodiment. Functional components 202 include functional surfaces to be exposed in the complete track and anchor surfaces, located opposite the functional surfaces, having anchors 203 extending from the anchor surface. By way of non-limiting example, functional components 202 can be removably coupled to or removably arranged adjacent to placeholders 106 via gravity, non-friction fit, clamping, fasteners, electromagnets, adhesive, etc. Moreover, in an exemplary completed track, these positioned and aligned functional components 202 can be utilized as maglev track components, e.g., guidance rails, levitation rails, propulsion rails, brake rails, etc., which correspond to components on the maglev vehicle, for transporting the maglev vehicle over or along the maglev track components.

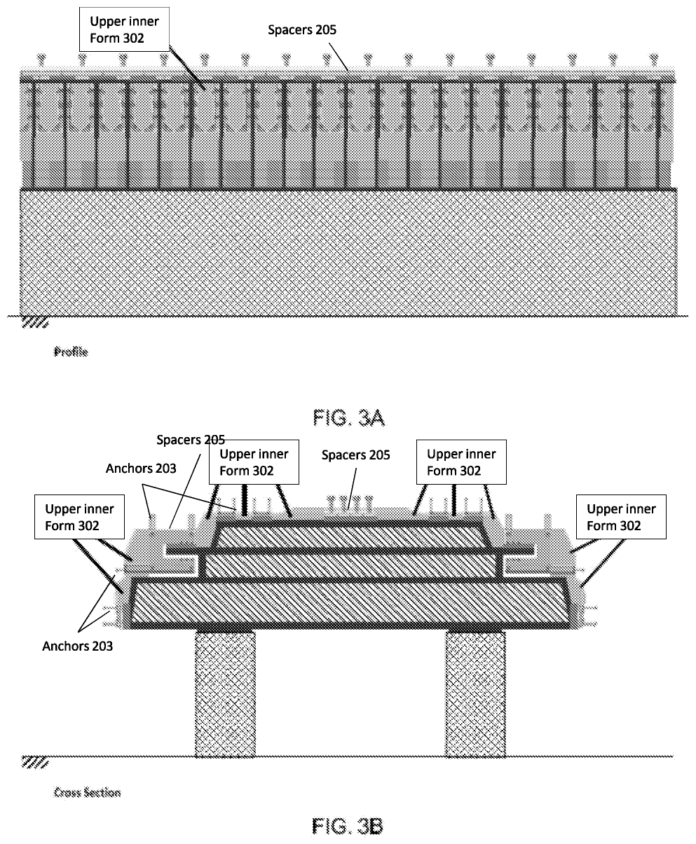

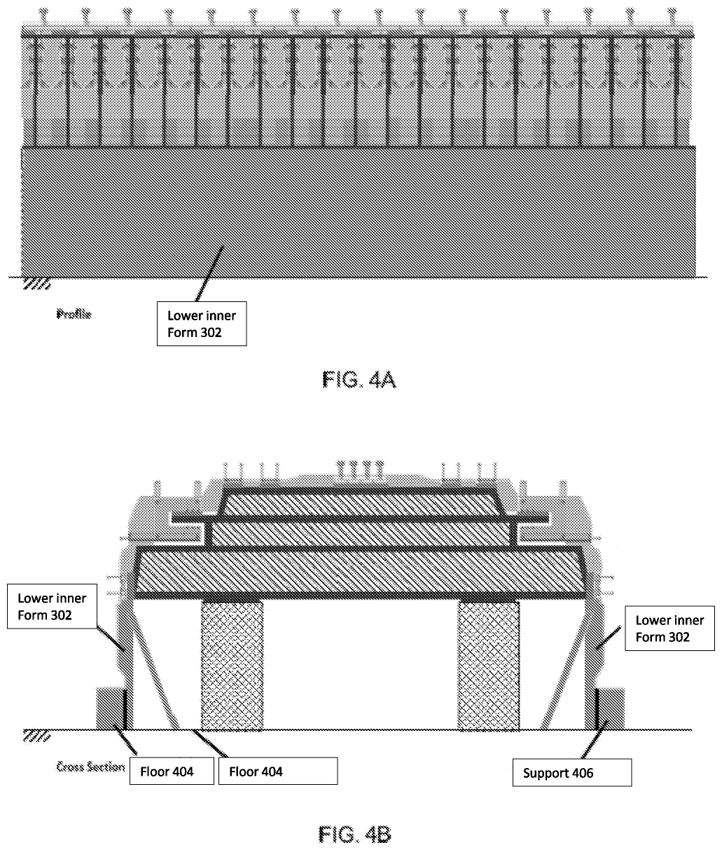

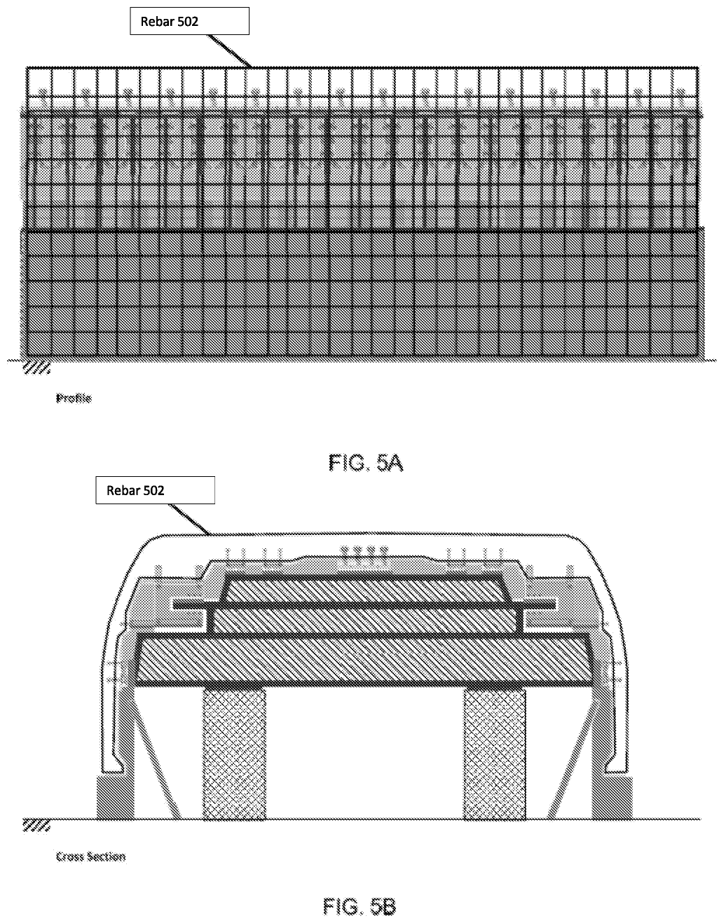

FIGS. 3A and 3B illustrate the exemplary profile view and cross-sectional view of FIGS. 2A and 2B, respectively, which includes the applying upper inner forms 302 over exposed surfaces of framework 104 and to cover lateral surfaces of functional components 302 so that the anchor surfaces and anchors 203 are left exposed. Upper inner forms 302 can extend in the length direction to form at least a temporary surface over which the deposited binder material, such as concrete or other moldable material, can be controlled or guided around functional components 202 of the track. Moreover, upper inner form 302 can also provide additional support for the precise positioning and alignment of functional components 202. Moreover, spacers 205 can be provided on the anchor side of components 202 to provide spacing from the completed walls and components 202, thereby making repairs and replacement of track pieces and other mechanical structures easier for maintenance personnel to perform.

FIGS. 4A and 4B illustrate the exemplary profile view and cross-sectional view of FIGS. 3A and 3B, respectively, where a lower inner form 402 has been added between framework 104, e.g., a bottommost surface of framework 104, and a floor 404, e.g., a concrete slab, on which bases 102 are supported, can extend in a length direction to form an at least additional temporary surface over which the deposited binder material, such a concrete or other moldable material, can be controlled and guided. Lower inner form 402 can be supported on floor 404. Moreover, lower inner form 402 can include a support 406 supported on floor 404 or a separate support 406 can be arranged on floor 404 adjacent inner form 402 as a structural support for the track assembly tool.

FIGS. 5A and 5B illustrate the exemplary profile view and cross-sectional view of FIGS. 4A and 4B, respectively, in which reinforcements (“rebar”) 502, which is supported on support 406, has been installed around and over upper inner form 302 in accordance with embodiments of the disclosure. Rebar 502, which may be one or more steel bars or a wire mesh, is provided to support and reinforce the deposited binder material, such as concrete or other moldable material.

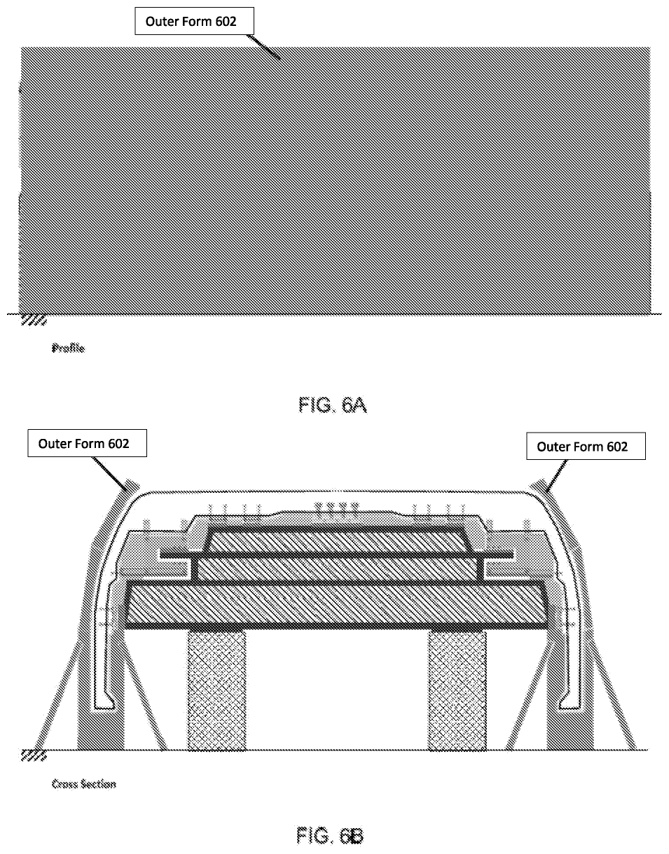

FIGS. 6A and 6B illustrate the exemplary profile view and cross-sectional view of FIGS. 5A and 5B, respectively, in which outer form 602 is applied over the lateral side of rebar 502. Preferably, outer form 602 can be supported on floor 404, or on support 406, and angled support elements can be located along the length of outer form 602 to maintain outer form 602 in its substantially vertical orientation. Outer form 602, which forms an outer surface for a mold for containing deposited binder materials, such as concrete or other moldable material, defines, with inner form 402, support 406 and upper inner form 302, an open volume or space in which rebar 502 is located.

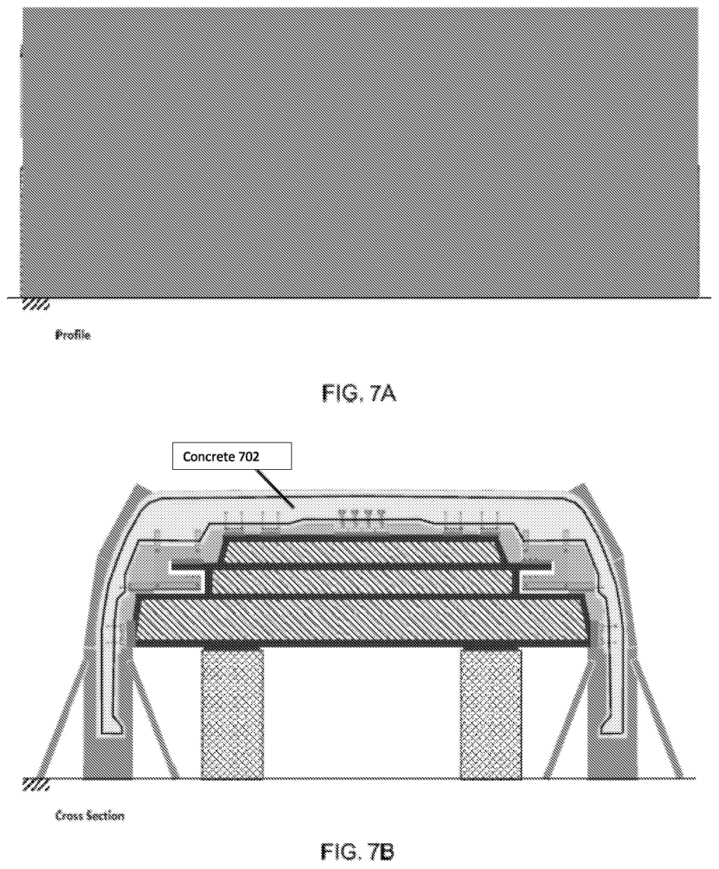

FIGS. 7A and 7B illustrate the exemplary profile view and cross-sectional view of FIGS. 6A and 6B, respectively, in which a binder material 702, such as concrete or other moldable material, is supplied or dispensed, e.g., through a top of the mold, to the open volume or space defined by inner form 402, support 406, outer form 602 and upper inner form 302 to cover rebar 502 and anchors 203.

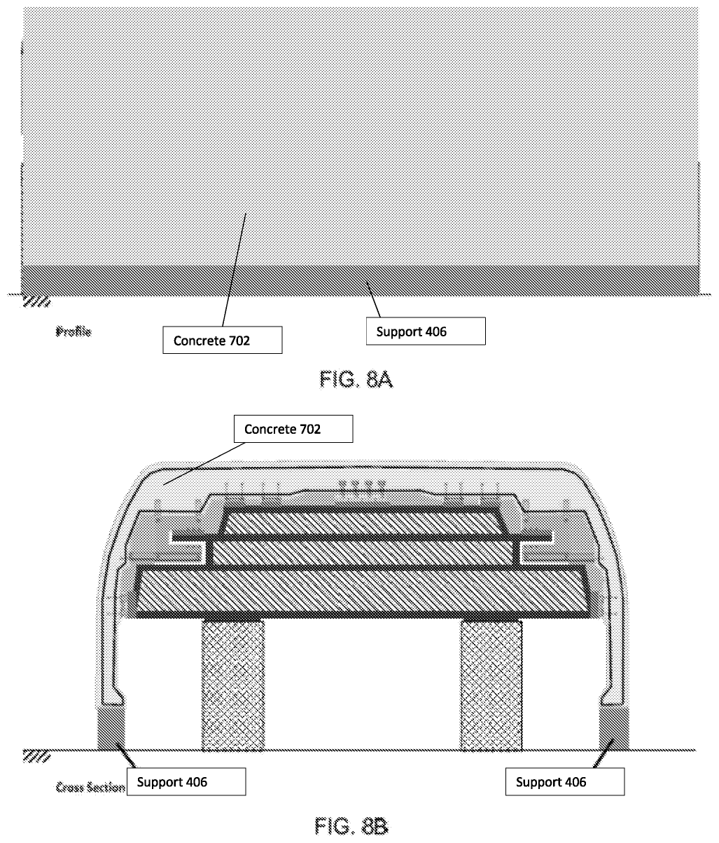

FIGS. 8A and 8B illustrate the exemplary profile view and cross-sectional view of FIGS. 7A and 7B, respectively, in which, when the binder material 702 has sufficiently hardened, outer form 602 and lower inner form 402 are removed from the mold or the hardened molded surfaces. In this way, the hardened binder 702, along with framework 104, functional elements 202 and upper inner form 302, are supported on supports 102 and 406.

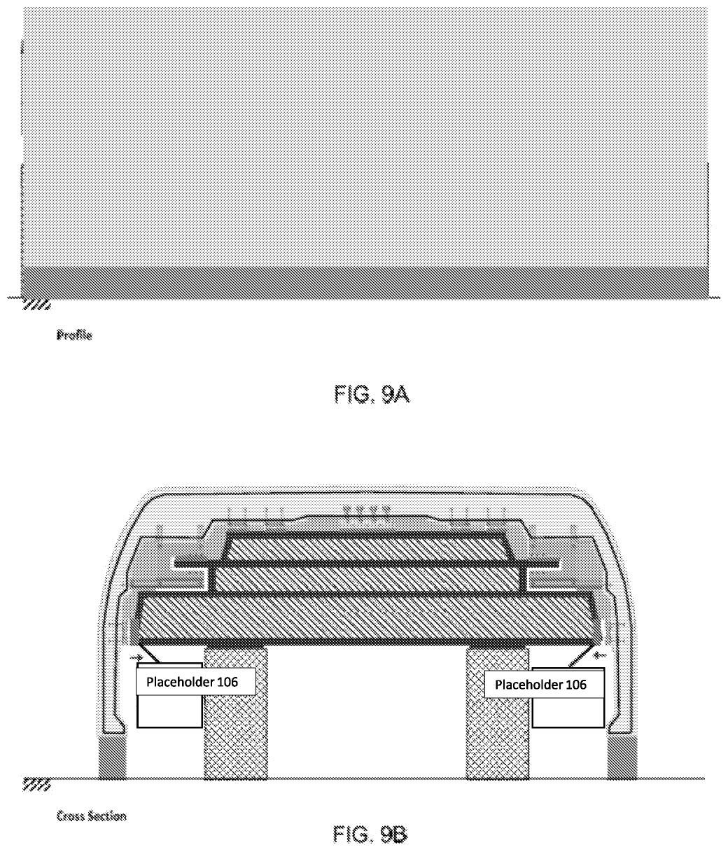

FIGS. 9A and 9B illustrate the exemplary profile view and cross-sectional view of FIGS. 8A and 8B, respectively, in which at least placeholders 106 located on the lateral sides of framework 104 are removed from functional components 202/framework 104. As anchors 203 of functional components 202 are held in hardened binder 702, functional components 202 are likewise held in place by hardened binder 702.

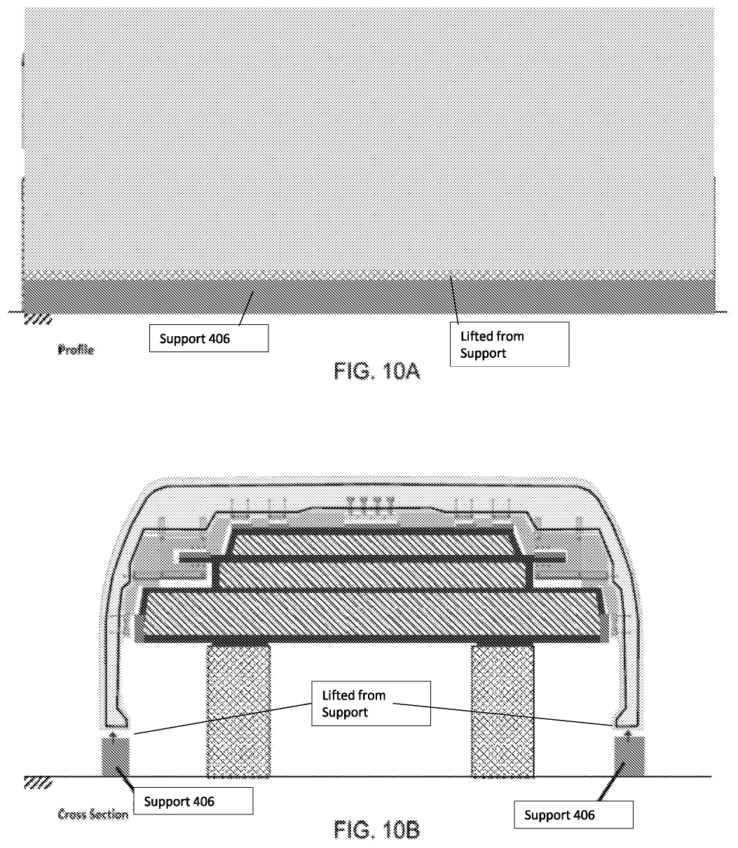

FIGS. 10A and 10B illustrate the exemplary profile view and cross-sectional view of FIGS. 9A and 9B, respectively, in which the formed section of track, which includes the functional components 202 anchored to the hardened binder 702, and the upper inner form 302 is lifted from support 406 and, thereby, lifted from framework 104 and the remaining placeholders 106, to facilitate removal of the track section from framework 104.

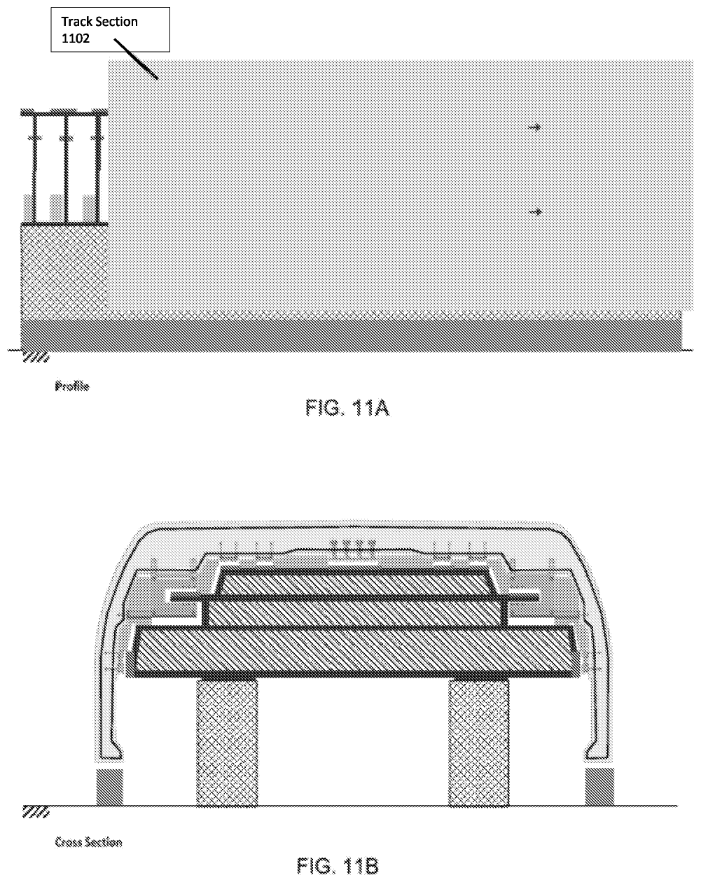

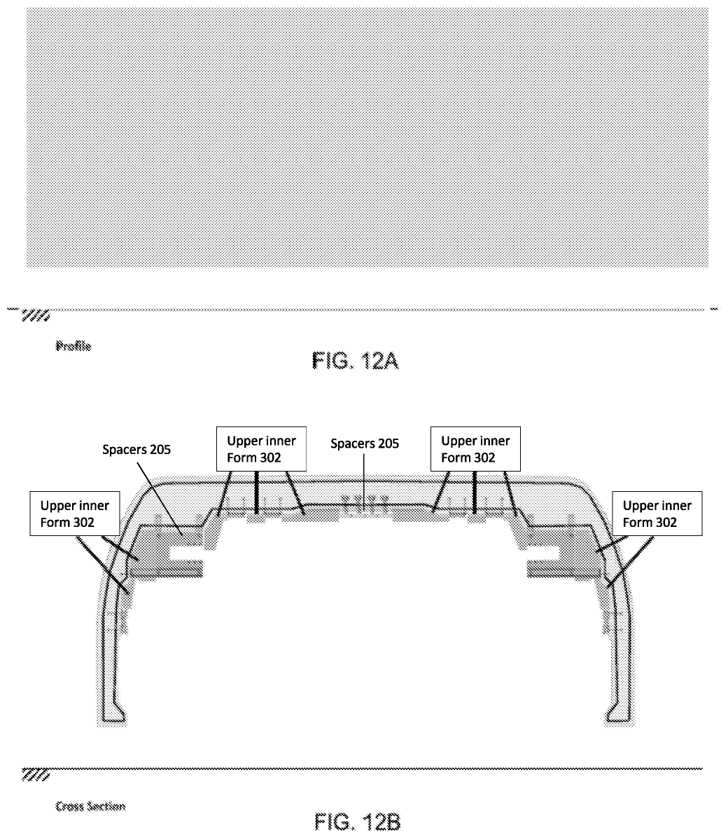

FIGS. 11 and 11B illustrate the exemplary profile view and cross-sectional view of FIGS. 10A and 10B, respectively, in which section of track 1102 and the upper inner forms 302 slide in the longitudinal direction relative to framework 104 to move framework 104 from track section 1102. In non-limiting alternatives, track section 102 can be moved in the longitudinal direction over or along framework 104 via rollers, sliding elements, being lifted with a crane, moving the supporting base etc.

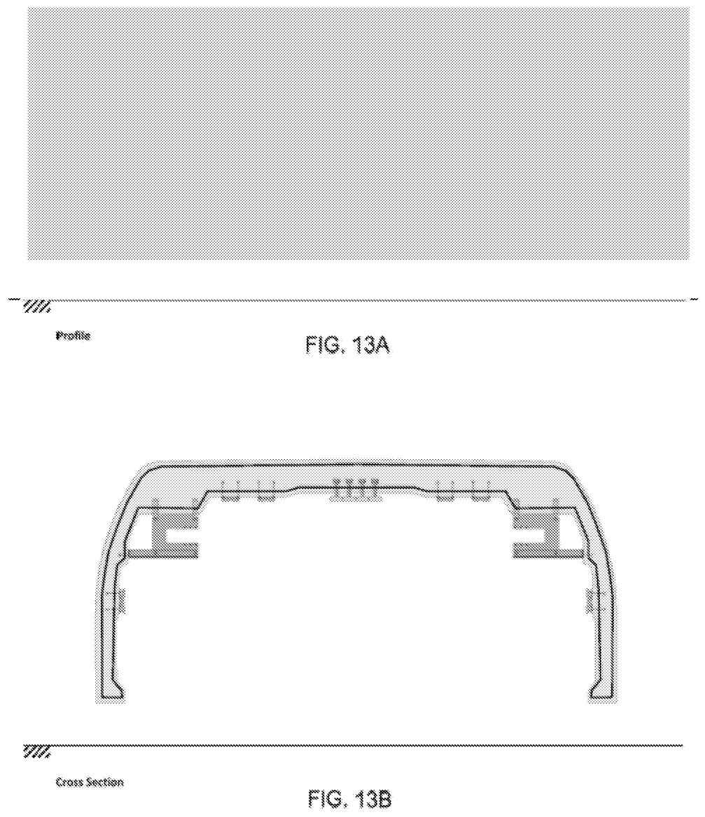

FIGS. 12A and 12B illustrate the exemplary profile view and cross-sectional view of FIGS. 11A and 11B, respectively, in which track section 1102 with upper inner forms 302 has been removed from framework 104 and supports 102. In embodiments, the track section 1102 removed from the track assembly tool may include upper inner forms 302 of FIGS. 3A and 3B.

FIGS. 13A and 13B illustrate the exemplary profile view and cross-sectional view of FIGS. 12A and 12B, respectively, in which upper inner forms 302 are removed from the track section. In this way, the track section is complete and ready for positioning and use. As is apparent from FIG. 13B, the functional surfaces of functional components 202 are open to the interior of the track section. Further, it is to be understood that the completed track section can be used for a guideway over which a maglev vehicle travels or as a guideway from which a maglev vehicle is suspended for travel.

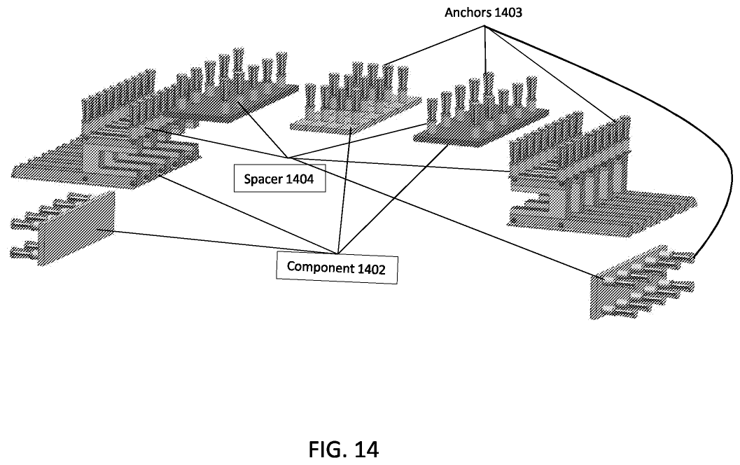

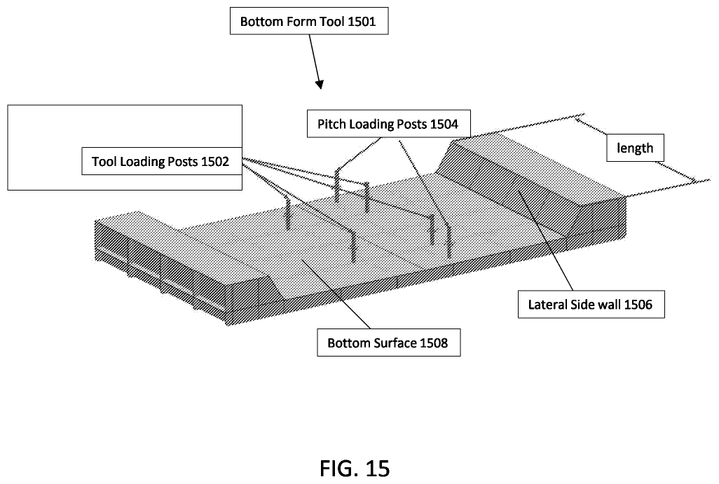

While the embodiments of FIGS. 1A-13B utilize temporary spacers during the fabrication process to produce space between the completed wall of the track section and desired functional components, it may be advantageous to provide spacers between the functional components and the anchors in the completed track section thereby allowing even easier repair and/or replacement of track features and/or mechanical structures of the track section by maintenance personnel. FIG. 14 illustrates an arrangement of components 1402 for a track section. As can be seen, each component 1402 can include a spacer 1404 located between anchor 1402 and component 1402. As in the previous embodiments, the functional components can be utilized for different purposes, e.g., levitation, braking, propulsion, guidance, etc., which correspond to components on the maglev vehicle, for transporting and guiding the maglev vehicle over or along the maglev track components. While FIG. 14 shows a specific arrangement of functional components, it is understood that other arrangements of functional components can be anchored to a completed wall in a section of track without departing from the spirit and scope of the invention. In particular, the specific arrangement of the functional components in the wall depends on design of the vehicle to be guided over and/or along the guideway.

In contrast to the embodiments described in FIGS. 1A-13B, the following embodiment is directed to fabricating the track section in a piece-wise fashion from the track or guideway up. However, the completed track section can be utilized for maglev vehicles designed to be guided over a guideway or for those maglev vehicles designed to be suspended from a guideway. In fabricating the track section, a bottom form tool 1501 is utilized. Bottom form tool 1501 includes, in a width direction, to lateral walls 1506 that are preferable obliquely oriented to a bottom surface 1508. Further, bottom surface 1508 includes guide holes into which tool loading posts 1502 and pitch loading posts 1504 are inserted. These posts 1502 and 1504, which can be, e.g., bolts that are screwed into the guide holes or metal posts frictionally fitted into the guide holes, can be understood as the primary control points for the positioning and alignment of the functional components 1402. In a length direction, the tool may be, e.g., 2-10 m long, preferably 6 m or less, and most preferably 3 m in length.

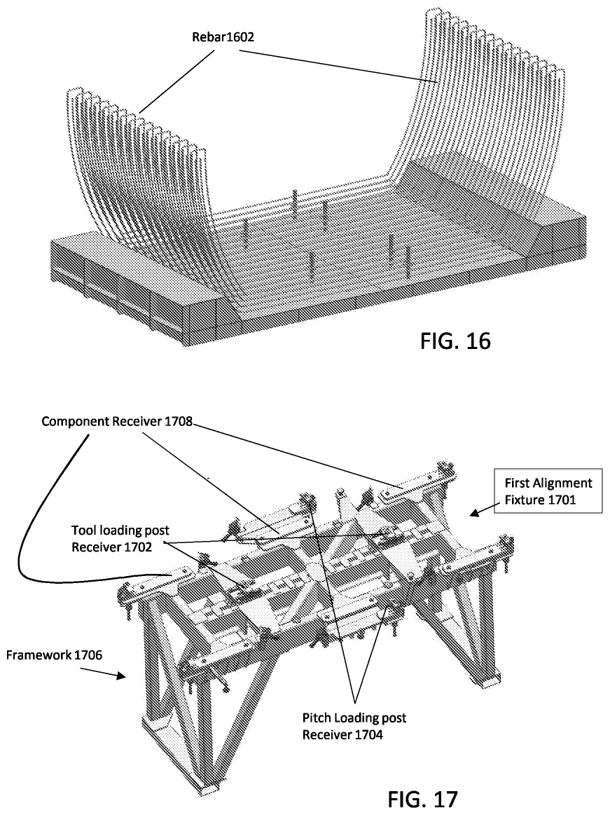

FIG. 16 illustrates rebar 1602, preferably steel, being arranged over bottom tool form 1501 so that the tool loading posts 1504 and the pitch loading posts 1506 extend through rebar 1602. Further, rebar 1602 can be bent upward at the lateral sides of bottom tool form 1501 into a U-shape that defines the contour of the section of track to be fabricated.

FIG. 17 illustrates a bottom view of a first alignment fixture 1701, which is formed by a framework 1706. To ensure proper positioning of first alignment fixture 1701, the bottom side includes tool loading post receivers 1702, which are configured to receive tool loading posts 1502, and pitch loading post receivers 1704, which are configured to receive pitch loading posts 1504. Further, first alignment fixture 1701 can also include component receivers 1708, which are configured to receive functional components 1402, e.g., for the levitation and braking of a maglev vehicle, and to temporarily clamp these components in place during placing and alignment of these functional elements in bottom form tool 1501.

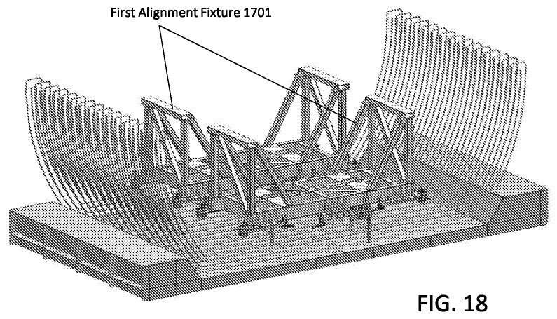

In FIG. 18, first alignment fixture 1701 is located over rebar 1502 so that tool loading post receivers 1702 receive tool loading posts 1502 and pitch loading post receivers 1704 receive pitch tool loading posts 1504. FIG. 18 shows two first alignment fixtures 1701, which is preferred, but it is understood that one or more than one such fixture can be utilized without departing from the spirit and scope of the invention. While it is preferred that the applicable functional components 1402 (including spacers 1404 and anchors 1403) are clamped into component receivers 1708 before the placement of first alignment fixture 1701 on tool loading posts 1502 and pitch loading posts 1504, the functional components, with spacers 1404 and anchors 1403 extending toward rebar 1502, are not illustrated to show the tool loading posts and pitch loading posts coupled to first alignment fixture 1701. In this way, as the first alignment fixture 1701 is placed on the loading posts, functional components 1402 can be positioned and aligned. Of course, it is understood that, after placing first alignment fixture 1701 on the tool loading posts 1502 and pitch loading posts 1504, the applicable functional components 1402 can be slid into component receivers 1708, clamped into place. If necessary, further positioning and alignment of functional components 1402 can be performed.

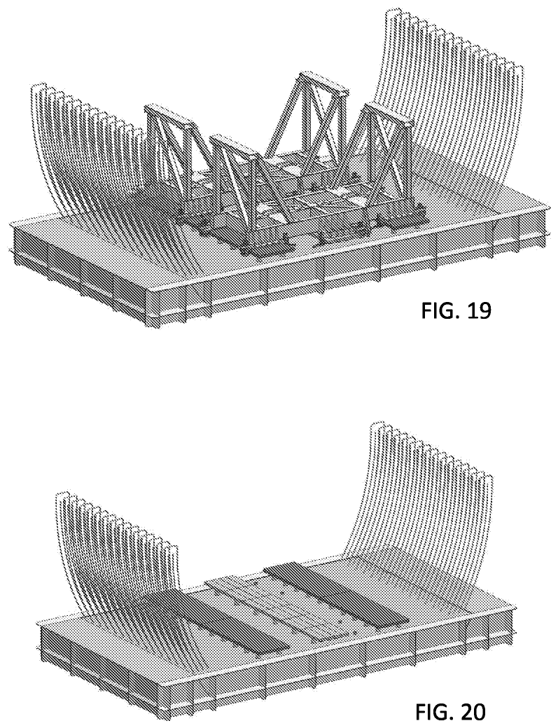

In FIG. 19, forms 1902 can be placed on the longitudinal ends of bottom form tool 1501, and binder material 1904, e.g., cement or other moldable material, can be dispensed into the opening. Binder material 1904 can be dispensed up to the bottoms of spacers 1404. Binder material 1904 is then given time to cure, as it must support the next layers to be poured and stabilize the track position. After curing, FIG. 20 shows positioned and aligned functional components the first alignment fixture removed.

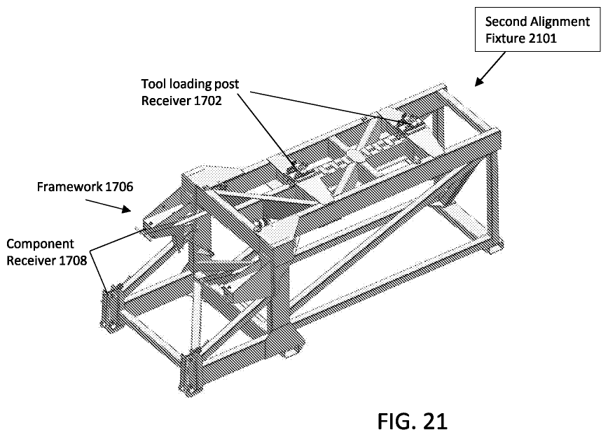

FIG. 21 illustrates a bottom view of a second alignment fixture 2101, which is formed by a framework 2106. To ensure proper positioning of second alignment fixture 2101, the bottom side includes tool loading post receivers 2102, which are configured to receive tool loading posts 1502. Further, second alignment fixture 2101 can also include component receivers 2108, which are configured to receive functional components 1402, e.g., for the propulsion and guidance of a maglev vehicle, and to temporarily clamp these components in place during placing and alignment of these functional elements over the cured binder material 1904 in bottom form tool 1501, as depicted in FIG. 20.

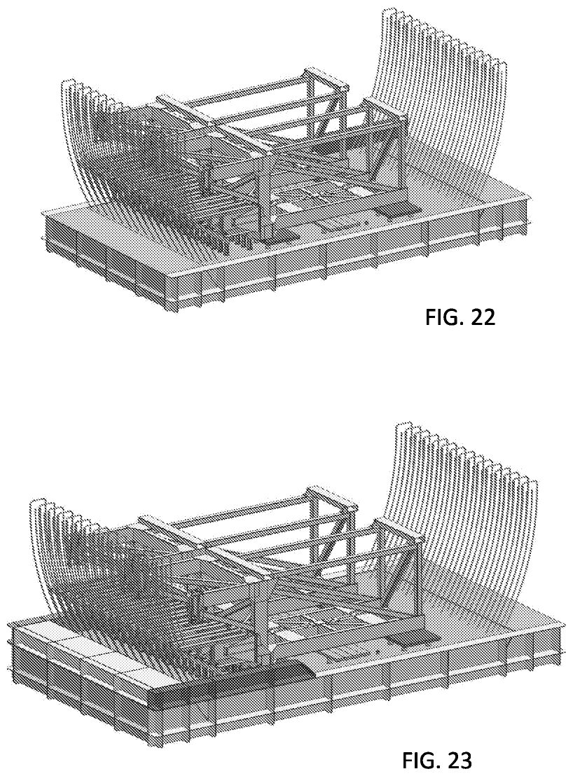

In FIG. 22, second alignment fixture 2101 is located over the functional components fixedly secured in the cured binder material so that tool loading post receivers 2102 receive tool loading posts 1502. FIG. 22 shows two second alignment fixtures 2101, which is preferred, but it is understood that one or more than one such fixture can be utilized without departing from the spirit and scope of the invention. In this embodiment, second alignment fixture 2101 only includes component receivers 2108 on one side, so that only one lateral side is formed at a time, as this assists in the removing of the tool after the binder material has cured, it is understood that component receivers 2108 could be provided on both lateral ends of second alignment fixture 2101.

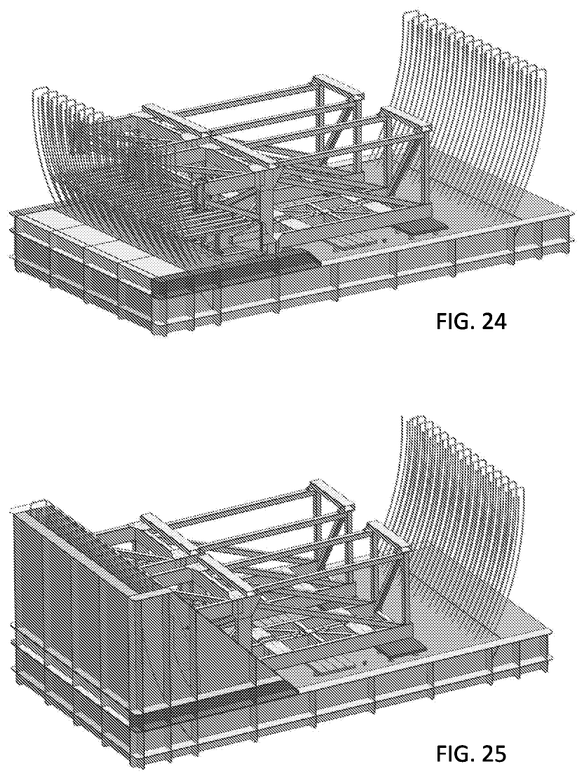

Once the applicable functional components are coupled to, e.g., via clamping, to the component receivers of second alignment fixture 2101, forms 2302 can be installed above bottom form tool 1501 to produce a mold to contain additional binder material to fixedly attach the next functional component, e.g., a propulsion rail, as shown in FIG. 23. The binder material is then dispensed into this mold, as shown in FIG. 24, and fixedly anchors the propulsion rail in place when it cures.

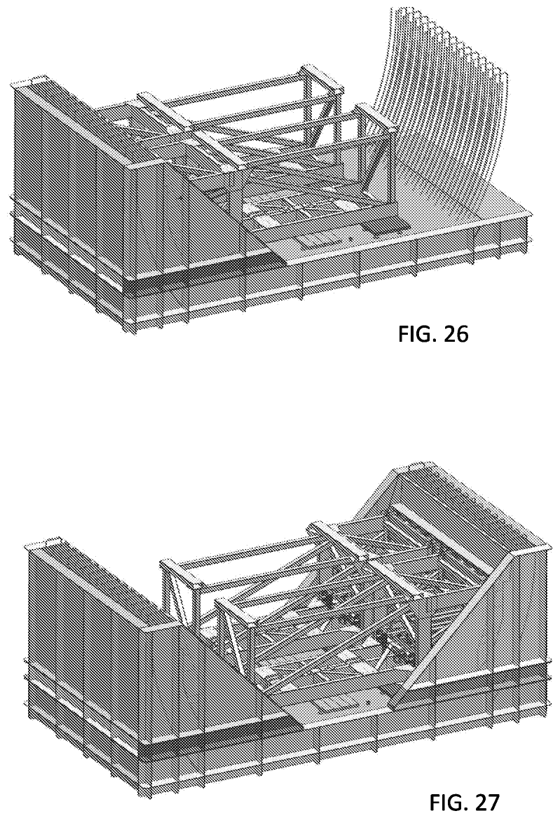

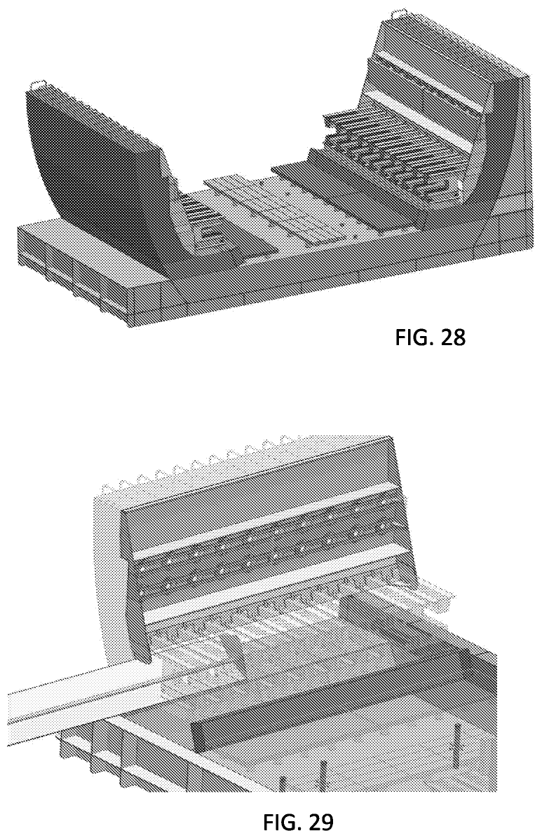

After this second stage of the fabrication process is completed, i.e., the binder material is cured, FIG. 25 shows forms 2502 can be installed above forms 2301. To complete the left-hand side of the track section, more binder material is dispensed into this new mold section to fixedly attach the next functional component, e.g., guidance rails, when cured, as shown in FIG. 26. The second alignment fixture 2101 is the removed from the left-hand side of the track section and turned around to repeat the process depicted in FIGS. 22-26 to form the right-hand side of the track section, as shown in FIG. 27. However, it is preferred that the forms 2302 and 2502 remain in place on the left-hand side until the right-hand side is complete and the binder material is fully cured. Upon completion of the track section, i.e., the binder material is fully cured, forms 2302 and 2502 can be removed to reveal track section 2802, see FIG. 28.

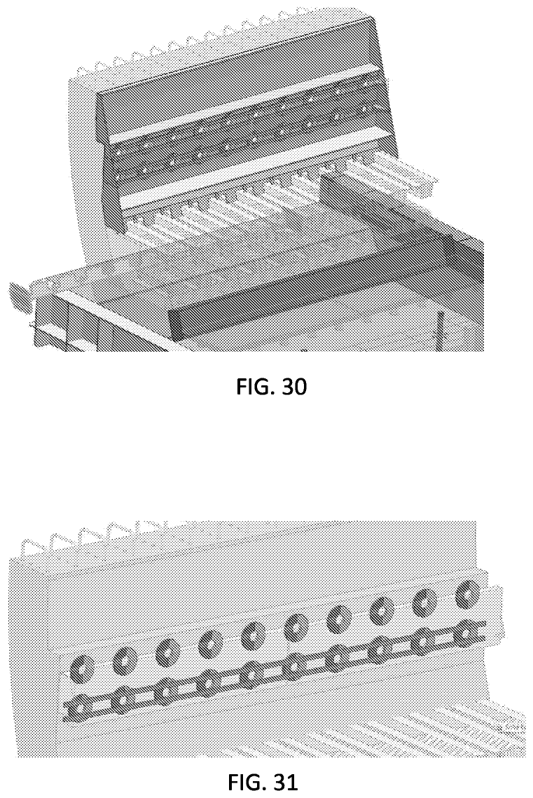

FIG. 29 shows the anchors for the guidance rails when the guidance rails and spacers are removed, e.g., for repair or replacement. Further, a steel angle iron or a wedge can be used to remove the lower interior section of the form. FIG. 30 illustrates removal of the center interior section of the form, allowing embedments to pass through the framework. FIG. 31 illustrates a method to seal the interior form around embedments that pass through the form.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

What is claimed is:

1. A method of forming a track section, comprising:
coupling functional components to a framework, wherein at least some of the functional components are arranged in a precise and accurate arrangement in a common plane;
building a rigid, removable, and reusable mold around the framework and functional components, wherein steel reinforcement (“rebar”), which is bent into a shape corresponding to a track section profile, is provided within the mold;
dispensing a binder material into the mold and curing the binder material;
removing the mold from the cured binder material to reveal a completed track section at the required accuracy set by the framework,
wherein at least some other functional components are arranged parallel to each other in a first lateral plane normal to the common plane and at least still other functional components are arranged parallel to each other in a second lateral plane normal to the common plane and parallel to the first lateral plane.

2. The method according to claim 1, wherein the at least some functional components in the common plane comprise levitation rails and braking rails.

3. The method according to claim 1, wherein the at least some other functional components and the at least still other components comprise guidance rails and propulsion rails.

4. The method according to claim 1, wherein the framework includes placeholders arranged to receive and position the functional elements coupled to the framework.

5. The method according to claim 1, wherein the functional elements comprise anchors arranged to extend within the shaped rebar.

6. The method according to claim 1, further comprising supporting the framework on at least one base supported on a ground surface.

7. The method according to claim 6, wherein the building of the mold comprises:
installing upper inner forms over upwardly facing portions of the framework and adjacent the functional components;
installing lower inner forms in a region between the framework and the ground surface, lower supports being located adjacent the lower inner forms, wherein the rebar is supported on the lower supports; and
installing outer forms over lateral sides of the track section shape of the rebar.

8. The method according to claim 7, wherein, after removing the mold, the completed track section is supported on the framework and the lower supports, and the method further comprises:
lifting the completed track section from the framework and the lower supports;
sliding, in a longitudinal direction, the completed track section relative to the framework and the lower supports; and
removing the upper inner forms from an interior of the completed track section.

9. The method according to claim 1, wherein the framework comprises a first alignment fixture and a second alignment fixture, and the method further comprises supporting the first alignment fixture on a bottom tool form,
wherein the bottom tool form includes a plurality of tool locating post holes and a plurality of pitch locating post holes, into which a plurality of tool locating posts and a plurality of pitch locating posts are inserted,
wherein the first alignment fixture comprises holes to receive the plurality of tool locating posts and the plurality of pitch locating posts and component receivers for retaining the at least some of the functional components to be arranged parallel to each other in the common plane,
wherein the first alignment fixture is supported above the rebar and the method further comprises positioning and aligning the at least some of the functional components, whereby the at least some of the functional components are arranged parallel to each other in the common plane.

10. The method according to claim 9, wherein the building of the mold comprises installing lower forms over longitudinal ends of the bottom form tool;
wherein the dispensing of the binder material comprises dispensing the binder material to a level covering anchors of the at least some functional components and below the at least some functional components; and
wherein the at least some functional components comprise a levitation rail and braking rails.

11. The method according to claim 10, wherein, after a first predetermined curing period, the method further comprises:
removing the first alignment fixture from the bottom tool form;
supporting the second alignment fixture on the tool locating posts; and
coupling the at least some other functional components to the second alignment fixture in the first lateral plane normal to the common plane.

12. The mold according to claim 11, wherein the building of the mold further comprises installing a first intermediate form above a first lateral edge of the bottom tool form and above the lower form in a region of the first lateral edge of the bottom tool form, and
wherein the dispensing of the binder material further comprises dispensing the binder material to cover anchors of intermediate ones of the at least some other functional components and to provide a lateral separation between the intermediate ones of the at least some other functional components and the dispensed binder material; and
wherein the intermediate ones of the at least some other functional components comprise a propulsion rail.

13. The method according to claim 12, wherein, after a second predetermined curing period, the building of the mold further comprises installing an first upper form above the first intermediate form, and
wherein the dispensing of the binder material further comprises dispensing the binder material to cover anchors of upper ones of the at least some other functional components and to provide a lateral separation between from the upper ones of the at least some other functional components and the dispensed binder material; and
wherein the upper ones of the at least some other functional components comprise a guidance rail.

14. The method according to claim 13, wherein, after a third predetermined curing period, the method further comprises:
removing the second alignment fixture from the bottom tool form and from the at least some other functional components;
rotating the second alignment fixture and supporting the second alignment fixture on the tool locating posts; and
coupling the at least still other functional components to the second alignment fixture in the second lateral plane normal to the common plane and parallel to the first lateral plane.

15. The mold according to claim 14, wherein the building of the mold further comprises installing a second intermediate form above a second lateral edge of the bottom tool form and above the lower form in a region of the second lateral edge of the bottom tool form, and
wherein the dispensing of the binder material further comprises dispensing the binder material to cover anchors of intermediate ones of the at least still other functional components and to provide a lateral separation between the intermediate ones of the at least still other functional components and the dispensed binder material; and
wherein the intermediate ones of the at least still other functional components comprise a propulsion rail.

16. The method according to claim 15, wherein, after a fourth predetermined curing period, the building of the mold further comprises installing an second upper form above the second intermediate form, and
wherein the dispensing of the binder material further comprises dispensing the binder material to cover anchors of upper ones of the at least still other functional components and to provide a lateral separation between from the upper ones of the at least still other functional components and the dispensed binder material; and
wherein the upper ones of the at least still other functional components comprise a guidance rail.

17. The method according to claim 16, wherein, after a fifth predetermined curing period, the first and second upper forms, the first and second intermediate forms and the lateral forms are removed to reveal a completed track section.

18. A track section tool for fabricating a track section, comprising:
a framework; and
a plurality of placeholders connected to the framework, wherein the plurality of placeholders are arranged to retain functional components to the framework during fabrication;
wherein the plurality of placeholders are arranged to orient at least some of the functional components in a precise and accurate arrangement in a common plane, to orient at least some other of the functional elements parallel to each other in a first lateral plane normal to the common plane, and to orient at least still other functional components parallel to each other in a second lateral plane normal to the common plane and parallel to the first lateral plane, and
wherein the at least some functional components in the common plane comprise a levitation rail and a braking rail, the at least some other functional components and the at least still other components comprise a guidance rail and a propulsion rail.

19. The track section tool according to claim 18, further comprising:
a bottom tool form having a plurality of tool locating post holes and a plurality of pitch locating post holes, and
a plurality of tool locating posts and a plurality of pitch locating posts being insertable into the plurality of tool locating post holes and the plurality of pitch locating post holes.

20. The track section tool according to claim 19, wherein the framework comprises:
a first alignment fixture having holes to receive the plurality of tool locating posts and the plurality of pitch locating posts and component receivers for retaining the at least some of the functional components to be arranged parallel to each other in the common plane, and
a second alignment fixture having holes to receive the plurality of tool locating posts and the plurality of pitch locating posts and component receivers for retaining one of the at least some other functional components in the first lateral plane or the at least still other functional components in the second lateral plane.
